(19) United States
(12) Patent Application Publication
(10) Pub. No.: US 2023/0161905 A1
(43) Pub. Date: May 25, 2023

(54) FIRECOMMENDATION METHOD, DEVICE, AND SYSTEM FOR DISTRIBUTED PRIVACY-PRESERVING LEARNING

(71) Applicant: Alibaba Damo (Hangzhou) Technology Co., Ltd., Hangzhou (CN)

(72) Inventors: Jingren Zhou, Bellevue, WA (US); Bolin Ding, Redmond, WA (US); Zitao Li, Hangzhou (CN)

(21) Appl. No.: 17/993,832

(22) Filed: Nov. 23, 2022

(30) Foreign Application Priority Data
Nov. 24, 2021 (CN) 202111405913.8

(51) Int. Cl. G06F 21/62; G06N 20/00

(52) U.S. Cl. CPC G06F 21/6245; G06N 20/00

(57) ABSTRACT

A target user terminal device among a plurality of user terminal devices performing federated learning acquires a scoring matrix corresponding to a target user, and performs the following operations in at least one iteration of training an item embedding matrix and a user embedding matrix corresponding thereto: determining a loss function gradient corresponding to the item embedding matrix in a current iteration, and sending to a server the loss function gradient added with a first noise; if a survival notification sent by the server is received, sending to the server a second noise for reducing the noise added to the loss function gradient, so that the server updates the item embedding matrix based on an aggregation result of the loss function gradient added with the first noise and the second noise, and sends an update result to each of the user terminal devices.

### CROSS REFERENCE TO RELATED APPLICATIONS

This application claims priority to and is a continuation of Chinese Patent Application No. 202111405913.8, filed on 24 Nov. 2021 and entitled “RECOMMENDATION METHOD, DEVICE, AND SYSTEM FOR DISTRIBUTED PRIVACY-PRESERVING LEARNING,” which is incorporated herein by reference in its entirety.

### TECHNICAL FIELD

The present disclosure relates to the technical field of artificial intelligence, and, more particularly, to recommendation methods, devices, and system for distributed privacy-preserving learning.

### BACKGROUND

With the continuous development of technologies such as the Internet of Things and the mobile Internet, the Internet is flooded with various information, posing challenges for users to search for effective information. In view of this, various recommendation models are designed in the conventional techniques for recommending information to which users may prefer.

An existing recommendation model faces the problems of isolated data island and data security in the training process. The industry continues to face important technical issues, that is, it must first protect user privacy data from misuse and leakage and at the same time recommend more personalized items to users. Therefore, to improve the performance of the recommendation models, these problems need to be overcome. To this end, a model training method for federated learning is proposed. Federated learning is a technology of distributed machine learning, which is a machine learning technology developed jointly among a plurality of data aggregators, wherein each data aggregator trains a model using its data and then integrates parameters of the trained model, so that the data used for model training may not leave the data aggregator, or the data may be encrypted or sensitive information therein may be eliminated when the data leave the data aggregator. The objective of federated learning is to guarantee the privacy, security, and compliance of training data on the premise of legal requirements, and to improve the efficiency of model training in a distributed training mode.

However, there is a special situation in practical applications: each of data aggregators participating in federated learning is each of the users, and the data of each user is only stored in its terminal device, often a mobile terminal device. This situation poses greater challenges for federated learning, one of which is that a user terminal device may drop out from the federated learning at any time. Therefore, in this situation, how to complete the learning and training of a recommendation model and guarantee the privacy security of user data is an urgent problem to be solved.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Embodiments of the present disclosure provide recommendation methods, devices, and systems for distributed privacy-preserving learning, which are used to complete the training of a recommendation model in a situation where a user terminal device may drop out from federated learning, and to guarantee user privacy security.

An example embodiment of the present disclosure provides a recommendation method for distributed privacy-preserving learning, wherein the method is applied to a target user terminal device among a plurality of user terminal devices configured to perform federated learning, the target user terminal device corresponds to a target user, and the method comprises:

locally acquiring a target scoring matrix corresponding to the target user, wherein the target scoring matrix is configured to describe a scoring situation of the target user on a plurality of items, and a scoring matrix collected by each of the plurality of user terminal devices has the same item set; and

performing the following operations during at least one iteration of locally iteratively training an item embedding matrix and a user embedding matrix corresponding to the target scoring matrix:

determining a loss function gradient corresponding to the item embedding matrix in a current iteration;

sending to the server the loss function gradient added with a first noise, so that the server determines a currently surviving user terminal device based on the received loss function gradient added with the first noise and sent by each of the user terminal devices;

in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device;

performing a next iteration according to the updated item embedding matrix and the user embedding matrix in the current iteration; and

predicting a degree of preference of the target user to the plurality of items according to the user embedding matrix and the item embedding matrix obtained at the end of training, and recommending items to the target user according to the degree of preference.

An example embodiment of the present disclosure provides a recommendation apparatus for distributed privacy-preserving learning, wherein the apparatus is applied to a target user terminal device among a plurality of user terminal devices configured to perform federated learning, the target user terminal device corresponds to a target user, and the apparatus comprises:

an acquisition module, configured to locally acquire a target scoring matrix corresponding to the target user, wherein the target scoring matrix is configured to describe a scoring situation of the target user on a plurality of items, and a scoring matrix collected by each of the plurality of user terminal devices has the same item set;

a training module, configured to perform the following operations during at least one iteration of locally iteratively training an item embedding matrix and a user embedding matrix corresponding to the target scoring matrix: determining a loss function gradient corresponding to the item embedding matrix in a current iteration; sending to a server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; and performing a next iteration according to the updated item embedding matrix and the user embedding matrix in the current iteration; and

a prediction module, configured to predict a degree of preference of the target user to the plurality of items according to the user embedding matrix and the item embedding matrix obtained at the end of training, and recommend items to the target user according to the degree of preference.

An embodiment of the present disclosure provides a user terminal device, wherein the user terminal device is a target user terminal device among a plurality of user terminal devices configured to perform federated learning, and the target user terminal device corresponds to a target user and comprises a processor and a display screen, wherein

the processor is configured to locally acquire a target scoring matrix corresponding to the target user, wherein the target scoring matrix is configured to describe a scoring situation of the target user on a plurality of items, and a scoring matrix collected by each of the plurality of user terminal devices has the same item set; and perform the following operations during at least one iteration of locally iteratively training an item embedding matrix and a user embedding matrix corresponding to the target scoring matrix: determining a loss function gradient corresponding to the item embedding matrix in a current iteration; sending to a server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; performing a next iteration according to the updated item embedding matrix and the user embedding matrix in the current iteration; and predicting a degree of preference of the target user to the plurality of items according to the user embedding matrix and the item embedding matrix obtained at the end of training, and recommending items to the target user according to the degree of preference; and

the display screen is coupled to the processor and configured to display the items recommended to the target user.

An embodiment of the present disclosure provides a non-transitory machine-readable storage medium, wherein the non-transitory machine-readable storage medium has executable codes stored thereon, which when executed by a processor of a user terminal device, cause the processor at least can implement the recommendation method for distributed privacy-preserving learning as described in the first aspect.

An embodiment of the present disclosure provides a distributed privacy-preserving learning system, which comprises:

a plurality of user terminal devices configured to perform federated learning, and a server; wherein the plurality of user terminal devices corresponds to a plurality of users one by one; a scoring matrix collected by each of the plurality of user terminal devices has the same item set;

a target user terminal device among the plurality of user terminal devices is configured to locally acquire a target scoring matrix corresponding to a target user, and perform the following operations during at least one iteration of locally iteratively training an item embedding matrix and a user embedding matrix corresponding to the target scoring matrix: determining a loss function gradient corresponding to the item embedding matrix in a current iteration; sending to the server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; performing a next iteration according to the updated item embedding matrix and the user embedding matrix in the current iteration; and predicting a degree of preference of the target user to a plurality of items according to the user embedding matrix and the item embedding matrix obtained at the end of training, and recommending items to the target user according to the degree of preference; and

the server is configured to receive the loss function gradient added with the first noise and uploaded by each of the user terminal devices in the current iteration, determine the currently surviving user terminal device, and send the survival notification to the currently surviving user terminal device; and receive the second noise sent by the currently surviving user terminal device, update the item embedding matrix based on the aggregation result of the loss function gradient added with the first noise and the second noise, and send the updated item embedding matrix to the surviving user terminal device.

In embodiments of the present disclosure, each user terminal device stores evaluation information of a corresponding user on a plurality of preset items (e.g., a plurality of movies), and accordingly, each user terminal device can generate a private scoring matrix. Each user terminal device can perform training of the corresponding user embedding matrix and item embedding matrix in a matrix factorization mode based on the private scoring matrix, and the finally obtained user embedding matrix and item embedding matrix form model parameters of a recommendation model to be trained. The scoring matrix can be factorized into a user embedding matrix and an item embedding matrix, wherein the item embedding matrix is configured to describe the attribute characteristics of an item, and the user embedding matrix is configured to describe the preference characteristics of a user. In addition, in order to ensure the performance of the recommendation model finally obtained by each user terminal device, in the training process, the federated learning training of the item embedding matrix can be performed on a plurality of user terminal devices by a server, so that each user terminal device can finally obtain a private user embedding matrix and a shared uniform item embedding matrix. Based on this, each user terminal device can predict a scoring value for each of the items by a user corresponding thereto based on a dot product result of the user embedding matrix and the item embedding matrix obtained at the end of training, and can sort a plurality of items according to the scoring values; a higher ranking means that the user is more likely to like the item, and the item recommendation to the user is completed accordingly.

In the above process of training the user embedding matrix and the item embedding matrix, the user embedding matrix is always iteratively updated locally on the user terminal device, while the item embedding matrix needs to be uploaded to the server for aggregation processing. For the item embedding matrix, in the current iteration, the loss function gradient corresponding to the item embedding matrix in the current iteration is determined, then a differential privacy noise, called a first noise, is added to the loss function gradient, and the loss function gradient added with the first noise is added to the server. The first noise is added to ensure that the gradient aggregated by the server still meets the differential privacy requirement in the worst situation where the drop-out rate of user terminal devices is very high. After receiving the above loss function gradient added with the first noise and sent by each of the user terminal devices, the server observes the currently surviving user terminal devices, and after observing the real surviving user terminal devices, sends a survival notification to the surviving user terminal devices to inform each of the surviving user terminal devices how many user terminal devices are currently surviving. For a user terminal device that has received the above survival notification, the second noise for reducing the noise added to the loss function gradient may be sent to the server at this time. At this time, the server aggregates the above loss function gradient added with the first noise and the second noise sent by each of the surviving user terminal devices, updates the item embedding matrix according to the aggregation result, and sends the updated item embedding matrix to each of the surviving user terminal devices, thus performing a next iteration according to the updated item embedding matrix and the user embedding matrix in the current iteration.

It can be seen that, in an iterative process, two-round interactions between a user terminal device and the server will be involved: in a first round of interaction, the user terminal device sends to the server a gradient added with a large noise (first noise), so that the server sends a survival notification to the surviving user terminal devices after observing the current real survival number of the user terminal devices (or real drop-out rate); in a second round of interaction, the surviving user terminal device sends another noise (second noise) to the server to eliminate redundant noise in the first noise sent before, so that the aggregated results of the server meet the differential privacy requirement matching the real drop-out rate of the user terminal devices, realizing the protection of user privacy.

### BRIEF DESCRIPTION OF DRAWINGS

In order to describe the technical solutions of the embodiments of the present disclosure more clearly, the accompanying drawings used for the description of the embodiments are briefly described below. Apparently, the accompanying drawings described below are some, instead of all, embodiments of the present disclosure. One of ordinary skill in the art can obtain other drawings according to these accompanying drawings without creative efforts.

FIG. 1 is a schematic diagram of a privacy boundary under an LFL according to an embodiment of the present disclosure;

FIG. 2 is a schematic diagram of a distributed privacy-preserving learning system according to an embodiment of the present disclosure;

FIG. 3 is a schematic diagram of a two-round interaction process between a terminal and a server according to an embodiment of the present disclosure;

FIG. 4 is a schematic diagram of another two-round interaction process between a terminal and a server according to an embodiment of the present disclosure;

FIG. 5 is a schematic flowchart of a federated learning process according to an embodiment of the present disclosure;

FIG. 6 is a schematic diagram of an application of a federated learning process according to an embodiment of the present disclosure;

FIG. 7 is a schematic structural diagram of an item recommendation apparatus according to an embodiment of the present disclosure;

FIG. 8 is a schematic structural diagram of a user terminal device according to the present embodiment; and

FIG. 9 is a schematic structural diagram of another user terminal device according to the present embodiment.

### DESCRIPTION OF EMBODIMENTS

In order to make the objectives, technical solutions, and advantages of the embodiments of the present disclosure clearer, the technical solutions in the embodiments of the present disclosure will be described clearly and completely hereinafter in conjunction with the accompanying drawings in the embodiments of the present disclosure. Apparently, the described embodiments are a part of, rather than all, embodiments of the present disclosure. Other embodiments obtained by those of ordinary skill in the art on the basis of the embodiments of the present disclosure without creative efforts all fall within the protection scope of the present disclosure.

In addition, the sequence of steps in the following method embodiments is only an example and is not to impose a strict limitation.

Matrix factorization (abbreviated as MF) is a basic issue in a recommendation system. As the name suggests, the matrix factorization is to factorize a matrix into two or more matrices, so that the factorized matrices can be multiplied to obtain the original matrix.

In fact, the problem faced by the recommendation system can be expressed as: the scoring of a large number of items by a large number of users may be collected to form a scoring matrix in which typically only some of the scoring values are known with certainty, and many of the scoring values are default, i.e., only scoring values of some users for some items can be collected. At this time, a recommendation model needs to be trained, so that the default scoring values can be predicted based on the recommendation model. It can be understood that the prediction results of the recommendation model for the known scoring values should be as equal as possible to the known scoring values. In this way, item recommendation can be performed on each of the users based on the trained recommendation model: according to a prediction result of a scoring value for each of the items by a certain user, a degree of preference of the user to each of the items (the higher the scoring value is, the more preferred the item is) is obtained, and a preferred item thereof is thereby recommended to the user. In practical applications, the items may be film and television works, commodities, game products, and the like.

The training of the above recommendation model actually is an MF issue: with a scoring matrix as an input, by learning to embed users and items as low-dimensional embedding vectors, a user embedding matrix is formed by user embedding vectors corresponding to all users, and an item embedding matrix is formed by item embedding vectors corresponding to all items, so that the dot product of the user embedding vectors and the item embedding vectors can be used to predict the degree to which the user likes an item. In fact, the user embedding matrix and the item embedding matrix are the model parameters of the recommendation model and the two matrices into which the scoring matrix is factorized.

In addition, data privacy security supervision is increasingly strengthened and planned currently, many data-driven services on the Internet face new challenges and opportunities, for example, when a recommendation model that recommends information to users is trained, the data security issue needs to be considered in the model training process.

In machine learning scenarios such as a recommendation model, one of the main problems faced is isolated data island, that is, each data aggregator owns a small amount of data for model training, the recommendation model is trained based on data owned by only one data aggregator, and the performance thereof is often poor. Therefore, in order to train a recommended model to have better performance, a machine learning framework for federated learning is developed.

Each party participating in the co-modeling can be called a data aggregator. In most federated learning frameworks, the data aggregator is generally an enterprise or an institution. According to the different data distribution characteristics among different data aggregators, federated learning can be classified into the following types: vertical federated learning (abbreviated as VFL), horizontal federated learning (abbreviated as HFL), and local federated learning (abbreviated as LFL).

Based on the above classification results of federated learning, the matrix factorization issue can be processed under different federated learning types, that is, recommendation models corresponding to different federated learning types are learned. Under each federated learning type, different data aggregators can jointly model based on their respectively collected scoring matrices without leaking the privacy data of their respective users.

Among them, under VFL, the scoring matrices respectively collected by all data aggregators share the same user set; however, there is no intersection on the item set. A typical scenario is that: two companies are located in the same region, one is an online content platform, the other is a local retailer, and both have the same customer base; however, the two companies each have different customer behavior information. If they want to cooperate to train a recommendation model, the recommendation model not only can learn watching behaviors of users on online content (such as videos and music), and also can learn purchasing behaviors of the users in local retail stores.

Under HFL, each data aggregator has a private user set; however, different data aggregators have the same item set. A typical scenario under HFL is that: different hospitals have different patient visit records, that is, different patient sets; however, different hospitals have the same disease set. At this time, different hospitals want to cooperate to train a disease prediction model (essentially a recommendation model).

LFL can be regarded as a special case of HFL. Under LFL, each user is a data aggregator and owns its scoring matrix. A typical scenario is that: in a mobile application, each user only stores its scoring information for some items in its terminal device, and does not want to share it with other users (data aggregators). In some mobile application scenarios, a situation where a recommendation model needs to be trained by combining private data information of a plurality of users belongs to LFL.

As mentioned above, under the federated learning framework, a plurality of data aggregators needs to be combined for joint modeling. If the plurality of data aggregators is directly allowed to interact with each other with their respective user data for joint modeling, it will lead to a user data security issue, and in particular, there is a need to ensure that user data does not leave the data aggregator authorized by the user without authorization under conditions prescribed by the law. This means user data cannot be shared among different data aggregators. Therefore, technical means are needed to achieve the purpose of combining a plurality of data aggregators for joint modeling, and at the same time, prevent user data from leaving the data aggregators, in which especially the user privacy information (sensitive information) cannot be leaked out of the data aggregators.

In order to avoid direct information interaction among different data aggregators, in the federated learning system provided by the embodiment of the present disclosure, a server will be set to perform federated learning training in combination with a plurality of data aggregators. In the process of federated learning training, each of the data aggregators will perform iterative training locally, and some model parameters generated in the process of local training need to be shared with the server, so that the server combines the model parameters shared by each of the data aggregators to optimize the model parameters to guide each of the data aggregators to update the model parameters obtained by local training; therefore, semantic information learned from user data of other data aggregators is merged into the private recommendation model finally obtained by each of the data aggregators, and the quality of the model is improved.

The user privacy information actually is implied in the model parameters shared with the server. Under different federated learning types, the user privacy information owned by different data aggregators is different, for example, under VFL, scored items owned by different data aggregators are different, and under HFL, user sets owned by different data aggregators are different. In the process of federated learning, the common information among different data aggregators needs to be jointly learned, while the difference information does not leave the data aggregators locally. Therefore, under VFL, what needs to be shared with the server is the user embedding matrix trained locally by each of the data aggregators, so that the user embedding matrix shared by each of the data aggregators can be protected for privacy; while under HFL, what needs to be shared with the server is the item embedding matrix trained locally by each of the data aggregators, so that the item embedding matrix shared by each of the data aggregators can be protected for privacy. For example, differential privacy can be used to protect the security of shared information. However, under VFL, the item embedding matrix that does not need to be shared is iteratively trained and updated locally at the data aggregators, and under HFL, the user embedding matrix that does not need to be shared is iteratively trained and updated locally at the data aggregators. Since LFL is a special case of HFL, the shared and private information is consistent with that of HFL, that is, the shared information is relevant parameter information of the item embedding matrix, while the private one is the user embedding matrix.

Based on the situation where user information cannot be shared among different data aggregators and there is information sharing between data aggregators and servers as described above, in fact, in order to guarantee the security of user information, different privacy boundaries can be set under different federated learning types. The privacy boundary is used to limit a boundary that cannot be crossed by the privacy information of a user, or that privacy protection is required when the boundary is crossed by the privacy information of the user.

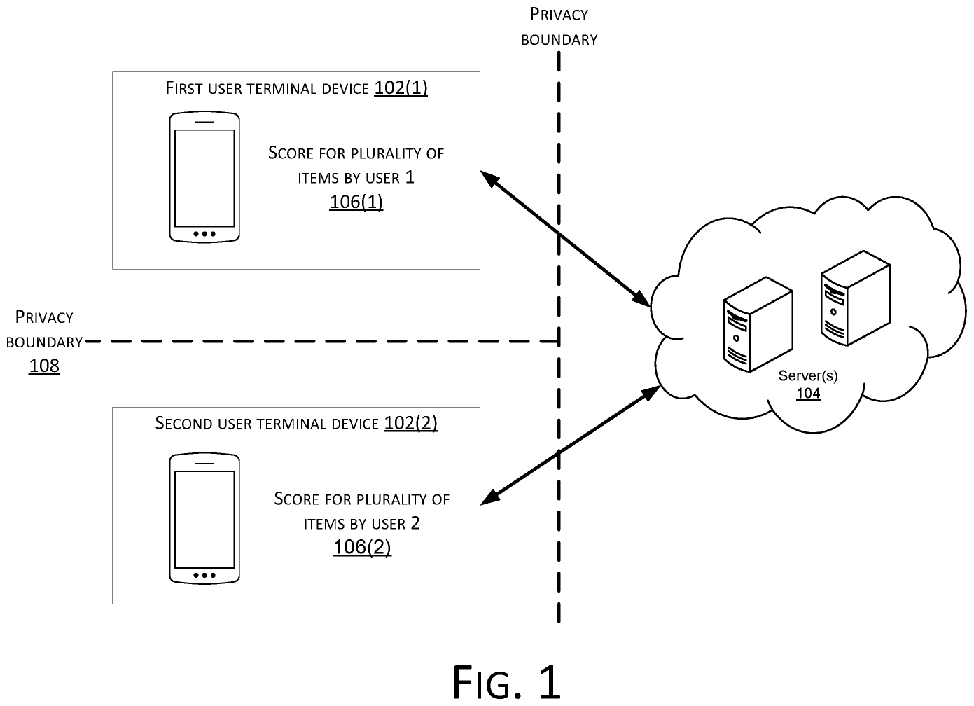

For example, in VFL and HFL, it can be considered that users trust their corresponding data aggregators, therefore, the users can directly provide their scoring information for a plurality of items to the corresponding data aggregators, and at this time, it is considered that there is no privacy boundary between the users and the data aggregators. However, for different data aggregators, there is a privacy boundary among different data aggregators, that is, it is required that different data aggregators cannot directly exchange information. In addition, there may also be a privacy boundary between different data aggregators and a server, and the privacy boundary is used to require that user privacy information shared by the data aggregators to the server is protected. In LFL, user data does leave its own terminal device, so there are privacy boundaries between all the user terminal devices and between user terminal devices and the server, as shown in FIG. 1. For example, in FIG. 1, the first user terminal device 102(1) and the second user terminal device 102(2) communicate with the server 104. The first user terminal device 102(1) stores data of score for a plurality of item by user 1 106(1). The second user terminal device 102(2) stores data of score for a plurality of item by user 1 106(1). The privacy boundary exists between the first user terminal device 102(1), the second user terminal device 102(2), and the server(s) 104.

In the embodiment of the present disclosure, aiming at the matrix factorization algorithm, a classic technical issue in a recommendation system, a federated learning framework guaranteed by data privacy theory is provided, so that when user data are distributed to different data aggregators (such as user terminal devices), a plurality of aggregators can jointly model without leaking their user privacy.

In addition, the data aggregator involved in the embodiment of the present disclosure actually corresponds to the concept of a user, that is, each user is a data aggregator and owns its data that is usually stored in its user terminal device (for example, a mobile terminal such as a mobile phone) without sharing it with other users. In the embodiment of the present disclosure, the data owned by each user may be its scoring values for a plurality of items (for example, a plurality of movies), therefore, according to the scoring values for a plurality of items by the user, a scoring matrix corresponding to the scoring values may be generated; by solving the matrix factorization issue through federated learning, the user embedding matrix and item embedding matrix corresponding to the scoring matrix can be determined, and these two embedding matrices are the model parameters of the recommendation model.

In fact, this situation is equivalent to a completely distributed setting situation: each user locally owns its scoring information and a user embedding matrix, and cannot share the scoring information and the user embedding matrix with other users, while all users finally share the same item embedding matrix.

A detailed description for the implementation process of the solution provided by the present application is provided below in conjunction with the following embodiments.

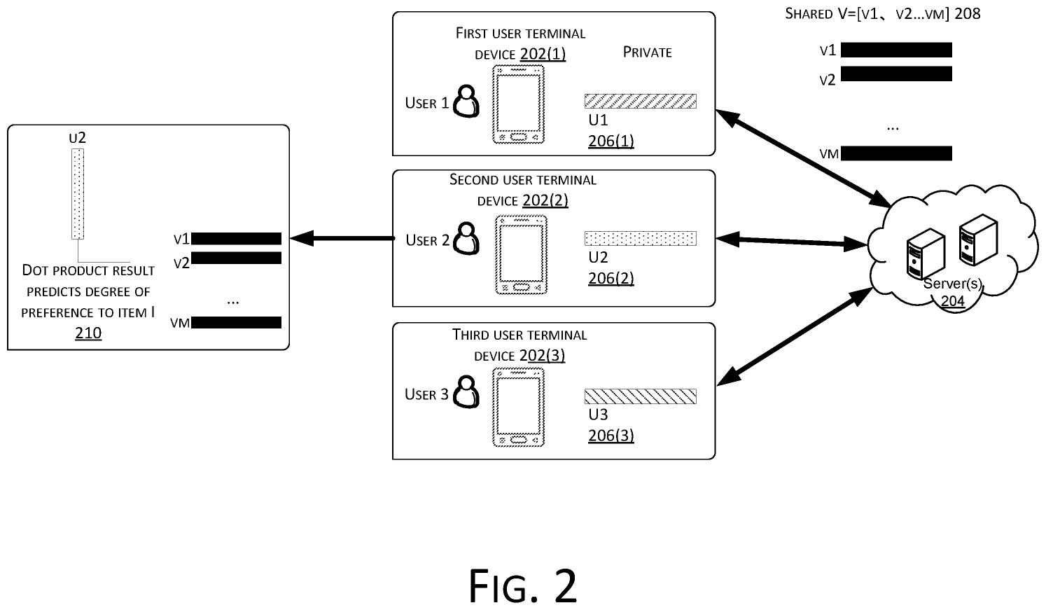

FIG. 2 is a schematic diagram of a distributed privacy-preserving learning system according to an embodiment of the present disclosure. As shown in FIG. 2, the system comprises a plurality of user terminal devices configured to perform federated learning and a server. For the convenience of description, FIG. 2 only illustrates a situation including a first user terminal device 202(1), a second user terminal device 202(2), a third user terminal device 202(3), and server(s) 204.

First, each user terminal device 102 can generate a corresponding scoring matrix based on locally collected user data. The scoring matrix reflects a scoring situation for a plurality of items by the corresponding user. Each user terminal device has the same item set; however, because the users corresponding to the user terminal devices are different, the user terminal devices each have different user sets.

In practical applications, in different recommendation applications, items that need to be recommended to users are different, for example, commodities, music, movies, and the like can be recommended to the users. Therefore, for different information recommendation requirements, the user data that a user terminal device needs to collect locally is different. For example, in a commodity recommendation application, what needs to be collected is the commodity order data of a user through a certain e-commerce APP on its user terminal device; in a music recommendation application, what needs to be collected is the listening data of a user through a music APP on its user terminal device; similarly, in a video recommendation application, what needs to be collected is the data of a video watched and added to favorites by a user through its user terminal device.

Each user terminal device may generate a corresponding scoring matrix based on the above collected user data.

For example, in the above commodity recommendation application, the server can determine a plurality of commodities that need to be evaluated (the item set is a commodity set at this time), and notify each of the user terminal devices of the commodity set. If it is found that a scoring value for a certain commodity by a corresponding user has been collected by each of the user terminal devices based on the locally collected user data, the scoring value is used as a scoring value corresponding to the commodity in the scoring matrix, and if it is found that no scoring value for certain commodity by a corresponding user has been collected, the corresponding scoring value in the scoring matrix is set as a default value indicating that the scoring value is unknown, such as meeting “-.”

For another example, in the above movie recommendation application, the server can determine a plurality of movies that need to be evaluated (the item set is a movie set at this time), and notify each of the user terminal devices of the movie set, and each of the user terminal devices generates a corresponding scoring matrix based on the locally collected user watching records and movie ticket purchase records, where if it is found that a watching or movie ticket purchase record of a certain movie by a corresponding user has been collected, a scoring value corresponding to the movie in the scoring matrix may be set as 1, and if it is found that no watching or movie ticket purchase record of some of the movies by a corresponding user has been collected, the corresponding scoring value in the scoring matrix is set as a default value indicating that the scoring value is unknown.

The setting of the scoring values in the scoring matrix above is only an example, and is not limited thereto.

The server 204 illustrated in FIG. 2 refers to a server configured to perform federated learning, that is, a server that combines various user terminal devices to jointly perform recommendation model training.

In a practical application, the server 204 is located in a cloud. Several computing nodes can be deployed in the cloud, and each computing node has processing resources such as computing and storage. In the cloud, a plurality of computing nodes can be organized to provide a certain service. Of course, one computing node can also provide one or more services. The way that the cloud provides the services may be to provide a service interface externally, and a user invokes the service interface to use a corresponding service. The service interface includes a software development kit (abbreviated as SDK), an application programming interface (abbreviated as API), and other forms.

For the solution provided by the embodiment of the present disclosure, the cloud can provide a service interface with a model training service, and the user terminal device triggers a corresponding request to the cloud by invoking the service interface. The cloud determines a computing node that responds to the request, and uses the processing resources in the computing node to execute the processing process related to the “server” in the embodiment of the present disclosure, and at this time, the server is the computing node that responds to the request.

In summary, the scoring matrix of each user terminal device is finally factorized into a user embedding matrix and an item embedding matrix for predicting scoring values for a plurality of items by a corresponding user through the process of federated learning training; the scoring matrix of each user terminal device is the privacy data of the corresponding user, and each of the user terminal devices only has intersection on the scored item set, so that the scoring matrix and the user embedding matrix of each of the user terminal devices are private on the user terminal device side and cannot be shared, while the item embedding matrix is shared. Therefore, as shown in FIG. 2, the training result of the recommendation model is that: each of the user terminal devices obtains its private user embedding matrix and a shared item embedding matrix. In FIG. 2, the private user embedding matrices of the illustrated three user terminal devices are denoted as u1 206(1) corresponding to the first user terminal device 202(1), u2 206(2) corresponding to the second user terminal device 202(2), and u3 206(3) corresponding to the third user terminal device 202(3), respectively, and the shared item embedding matrix 208 is denoted as V=[v1, v2, . . . , vm], where v1 denotes an embedding vector corresponding to the i^{th} item, and it is assumed here that there are m items.

Among them, the user embedding matrix is used to describe the preference characteristics of a user, that is, the interest degree of the user in an item with certain attribute characteristics; the item embedding matrix is used to describe attribute characteristics of the items. For a scoring matrix, the scoring matrix is approximately equal to a dot product of the user embedding matrix and the item embedding matrix corresponding thereto.

In the above example, for example, for the second user terminal device, based on the dot product result 210 of the user embedding matrix u2 and the item embedding matrix V corresponding to the second user terminal device 202(2), it can be known that the degree of preference of the user 2 corresponding to the second user terminal device 202(2) to ith items among the m items (the predicted scoring value represents the degree of preference, and the higher the scoring value is, the higher the degree of preference is), so that the m items can be ranked based on the degree of preference, and items are recommended to the user 2 according to the ranking result, for example, a set number of items ranked at the top are recommended.

As described above, the model parameters of the recommendation model to be trained in the embodiment of the present disclosure mainly include a user embedding matrix and an item embedding matrix. The user embedding matrix and the item embedding matrix are matrices obtained by the matrix factorization of the scoring matrix. That is to say, in the embodiment of the present disclosure, the training of the recommendation model is converted into the matrix factorization issue. The training of the recommendation model is realized by solving the matrix factorization issue under the federated learning framework, which, therefore, can be called a federated matrix factorization solution.

In the embodiment of the present disclosure, the implementation structure of the recommendation model is not limited, and the recommendation model mainly functionally includes an embedding layer and an outputting layer, where the embedding layer is used to encode the input scoring matrix to obtain the corresponding user embedding matrix and item embedding matrix. The outputting layer is mainly used to output the dot product result of the user embedding matrix and the item embedding matrix, and calculate a loss function.

It can be understood that the training of the recommendation model is performed continuously through loop iterations. That is to say, the user embedding matrix and item embedding matrix will be iteratively updated continuously. In each iteration process, the computation of the corresponding loss function gradient is performed, so that the corresponding embedding matrix is updated by a back propagation algorithm such as a stochastic gradient descent method.

The federated learning mode provided by the embodiment of the present disclosure does not mean that the server collects the scoring matrix of each of the user terminal devices to form a complete scoring matrix, performs model training based on the complete scoring matrix, and finally distributes the training result to each of the user terminal devices for use. Instead, each of the user terminal devices finally obtains a recommendation model respectively used by each of the user terminal devices based on a respectively collected scoring matrix, and the private recommendation model of each of the user terminal devices is different due to different user embedding matrices therein, so that the server is only needed to assist in aggregating relevant intermediate information in the training process of the respectively corresponding recommendation model, so as to improve the performance of the model.

In combination with the above description, in the process of training the private recommendation model of each of the user terminal devices by a server in combination with a plurality of user terminal devices, in summary, the main operations involved in the training process of each of the user terminal devices and the server are as follows:

a target user terminal device is configured to locally acquire a target scoring matrix corresponding to a target user, and perform the following operations during at least one iteration of locally iteratively training an item embedding matrix and a user embedding matrix corresponding to the target scoring matrix: determining a loss function gradient corresponding to the item embedding matrix in a current iteration; sending to the server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on the aggregation result of the loss function gradient added with the first noise and the second noise, and sends the updated item embedding matrix to the surviving user terminal device; performing a next iteration according to the updated item embedding matrix and the user embedding matrix in the current iteration; and predicting the degree of preference of the target user to a plurality of items according to the user embedding matrix and the item embedding matrix obtained at the end of training, and recommending items to the target user according to the degree of preference.

The server is configured to receive the loss function gradient added with the first noise and uploaded by each of the user terminal devices in the current iteration, determine the currently surviving user terminal device, and send the survival notification to the currently surviving user terminal device; and receive the second noise sent by the currently surviving user terminal device, update the item embedding matrix based on the aggregation result of the loss function gradient added with the first noise and the second noise, and send the updated item embedding matrix to the surviving user terminal device.

The target user terminal device is any one of the plurality of user terminal devices, the corresponding user is called the target user, and the scoring matrix collected by the target user terminal device is called the target scoring matrix.

In LFL, what the user terminal device shares with the server is the loss function gradient information corresponding to the item embedding matrix, and the loss function gradient information may actually leak user data; therefore, the protection by introducing noise during the transmission to the server can prevent leakage of user data and guarantee the security of user data.

In practical applications, the local training process of each of the user terminal devices is completed through a training iteration process, that is, a plurality of iteration processes is performed, and the training cutoff condition may be that a set number of iterations is reached.

In an iterative process, a predicted scoring value will be output based on the dot product result of the current user embedding matrix and the item embedding matrix; by comparing the difference between the predicted scoring value and the original scoring value in the corresponding scoring matrix, the loss function value can be obtained, then the loss function gradient can be calculated, and the user embedding matrix and the item embedding matrix can be updated by back propagation for a next round of iteration. Among them, the loss function gradient includes the gradient corresponding to the user embedding matrix and the gradient corresponding to the item embedding matrix.

In the embodiment of the present disclosure, there are many user terminal devices participating in federated learning training, and most of these user terminal devices may be mobile terminal devices, the network connection state between the mobile terminal devices and the server may be unstable, or some user terminal devices suddenly refuse to participate in the training because they need to be busy with processing other local tasks during the joint training process, which will lead to the occurrence of a user drop-out situation, that is, the user terminal device becomes unavailable. Therefore, in the process of combining many user terminal devices for federated learning training, it is a challenge to guarantee user privacy security with user terminal devices dropping out.

Differential privacy technology can be used to guarantee user privacy security. In summary, the use of differential privacy technology to guarantee user privacy security mainly involves adding differential privacy noise to the training parameters uploaded by a user terminal device to the server, and in the embodiment of the present disclosure, the above training parameters refer to the item embedding matrix obtained in the local training process of the user terminal device.

Therefore, there is a need to guarantee that the privacy guarantee ability of the differential privacy algorithm remains unchanged in the federated learning training described above, even if a large number of users drop out in one or more iterations.

First, the privacy guarantee ability of the differential privacy algorithm is briefly explained.

It is assumed that a total of n users (that is, n user terminal devices) participate in federated learning, and that the n user terminal devices do have the drop-out situation, then in a certain iteration process, each user terminal device can output a prediction result based on the user embedding matrix and the item embedding matrix used in this iteration, and calculates the loss function gradients corresponding to the user embedding matrix and the item embedding matrix, respectively, based on the loss function that can be calculated based on the prediction result and the corresponding scoring matrix, so as to update the user embedding matrix for the next iteration based on the loss function gradient corresponding to the user embedding matrix. For the loss function gradient corresponding to the item embedding matrix, it needs to be uploaded to the server for aggregation processing. That is to say, the server can aggregate the loss function gradients corresponding to the item embedding matrices received from the user terminal devices in the current iteration. The loss function gradient corresponding to the item embedding matrix uploaded by a user terminal device may leak a scoring situation of the corresponding user, and therefore, when the differential privacy algorithm is used to guarantee user privacy information, there is a need to add differential privacy noise to the loss function gradient before uploading. The added differential privacy noise is to make the aggregated result of the server satisfy the definition of differential privacy: (ε, δ)-DP. That is to say, the aggregation result of the noises contained in the loss function gradients corresponding to the item embedding matrices uploaded by the n user terminal devices satisfies that: the variance of the aggregated noise is σ². Then, the variance of the noise to be added to the loss function gradient uploaded by each user terminal device is σ²/n. It can be seen that, when there is no user terminal device dropping out, only a noise with the variance of σ²/n needs to be added to the gradient uploaded by each user terminal device to the server, so that the aggregated gradient can meet the differential privacy requirement.

However, in practical applications, the phenomenon that user terminal devices drop out is often unavoidable. In order to make the aggregated gradient on the server side meet the above differential privacy requirement, there is a need to know the real drop-out situation of user terminal devices, because the drop-out situation will affect the noise size added to the above loss function gradient obtained by surviving user terminal devices. The surviving user terminal device refers to a user terminal device that has not dropped out (i.e., that is available).

Therefore, in order to guarantee the differential privacy requirement based on the real user terminal device drop-out situation, the following solutions are provided in the embodiment of the present disclosure:

for a certain iterative process of the target user terminal device in a training with a plurality of iterations: performing dot product calculation on the user embedding matrix and the item embedding matrix used in the current iteration to obtain a prediction result, calculating a loss function based on the difference between the prediction result and a target scoring matrix, determining a loss function gradient gv corresponding to the item embedding matrix, and sending to a server a loss function gradient gv′ added with a first noise, so that the server determines currently surviving user terminal devices based on the received loss function gradient gv′ added with the first noise and sent by each of the user terminal devices. The server then sends a survival notification to the surviving user terminal devices. It is assumed that the target user terminal device receives the survival notification, it sends to the server a second noise for reducing the noise added to the loss function gradient gv. The server finally aggregates all the loss function gradients gv′ added with the first noise received in the local iteration and the second noise, updates the item embedding matrix based on the aggregation result, and sends the updated item embedding matrix to the surviving user terminal devices, including the above target user terminal device. The target user terminal device performs the next iteration according to the received updated item embedding matrix and the user embedding matrix in the current iteration.

It can be seen that, in an iterative process, two-round interactions between a user terminal device and the server will be involved: in a first round of interaction, the user terminal device sends to the server a gradient added with a large noise (first noise), so that the server sends a survival notification to the surviving user terminal device after observing the current real survival number of the user terminal devices (or real drop-out rate); in a second round of interaction, the surviving user terminal device sends another noise (second noise) to the server to eliminate redundant noise in the first noise sent before, so that the aggregated results of the server meet the differential privacy requirement matching the real drop-out rate of the user terminal devices, realizing the protection of user privacy.

The core idea of the above two-round interaction strategy is that: first, in order to deal with the worst user drop-out situation, a large noise is added; then, after a real user drop-out situation is observed, “unnecessary” and redundant noise in the larger noise is eliminated, so that the aggregated gradient meets the requirement of differential privacy definition.

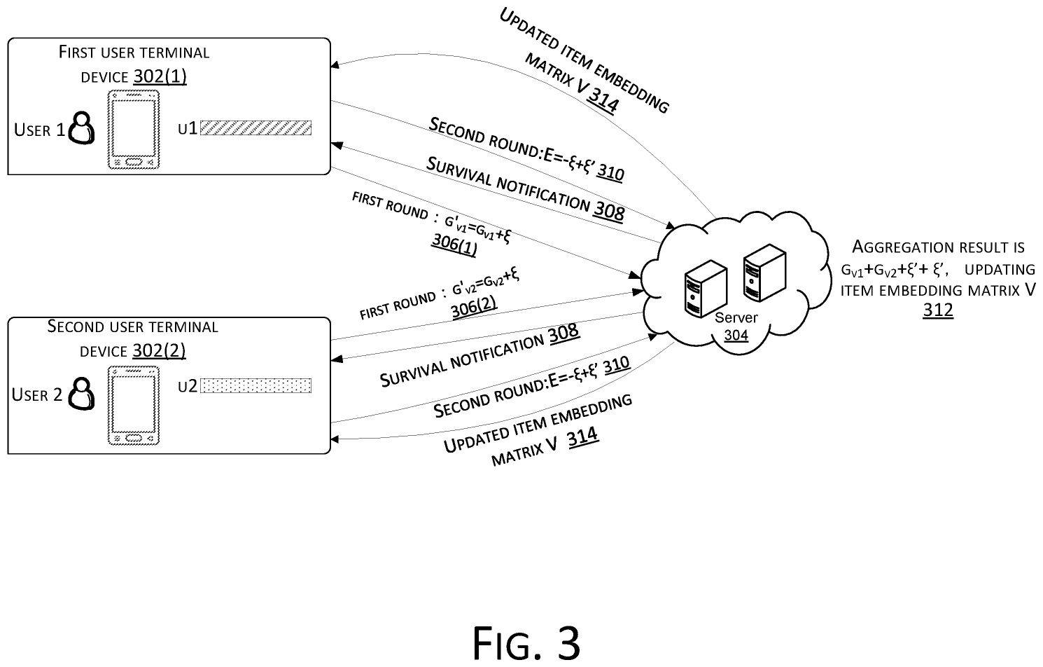

For the convenience of description, the loss function gradients corresponding to the item embedding matrices calculated by the first user terminal device and the second user terminal device in a certain iterative process are denoted as gᵥ₁ and gᵥ₂, respectively; as shown in FIG. 3, the above first noise is denoted as ξ, and the first user terminal device 302(1) and the second user terminal device 302(2) add the first noise to the above calculated gradients: g′ᵥ₁=gᵥ₁+g′ᵥ₂=gv_{2+.}

In practical applications, for example, the first noise may be zero-mean Gaussian noise and denoted as (0, ξ₁σ²), where σ² denotes variance, denotes variance coefficient, and the variance coefficient ξ₁≥1/(1-w)n. Among them, w is a set user drop-out rate, n is the total number of user terminal devices, and then (1-w)n denotes a set survival number threshold. It can be seen that the higher the user drop-out rate that can be tolerated (closer to 1), the larger noise needs to be added to guarantee differential privacy.

As shown in FIG. 3, in a first round of interaction, the first user terminal device 302(1) and the second user terminal device 302(2) send g′ᵥ₁ and g′ᵥ₂ to the server 304, respectively at 306(1) and 306(2).

If the server 304 receives the above information sent by the first user terminal device 302(1), the server 304 determines that the first user terminal device 302(1) in the current iteration has not dropped out (that is, it is surviving), and similarly, determines that the second user terminal device 302(2) in the current iteration is surviving; then, the server 304 determines that the number of the currently surviving user terminals is 2, and sends a survival notification 308 to the surviving first user terminal device 302(1) and second user terminal device 302(2) respectively, where the survival notification 308 may include the number of the currently surviving user terminal devices.

After receiving the above survival notification, the first user terminal device 302(1) and the second user terminal device 302(2) trigger a second round 310 of interaction with the server: the second noise is denoted as E, and E=−ξ+ξ′ is determined, where ξ′ is called a third noise, and the second noise is the difference between the third noise and the first noise. The third noise ξ′ may also be zero-mean Gaussian noise and denoted as (0, ξ₂σ²), ξ₂ is the variance coefficient of the third noise, the value of which is between the reciprocal of the number of the currently surviving user terminal devices and the reciprocal of the set survival number threshold. That is, if the number of the currently surviving user terminal devices is denoted as U1, then (1/U1)≤ξ₂≤1/(1-w)n. It can be seen that the third noise is smaller than the first noise.

After that, after receiving the second noise E respectively uploaded by the first user terminal device 302(1) and the second user terminal device 302(2), the server 304 performs aggregation processing 312 on g′ᵥ₁, g′ᵥ₂, −ξ+ξ′, and −ξ+ξ′, and the final addition sum result is gᵥ₁+gᵥ₂+ξ′+ξ′. It can be seen that the originally added large noise is replaced with the small noise determined based on the real user survival situation, so that the aggregated gradient of the surviving user terminal devices meets the differential privacy requirement. After that, the item embedding matrix is updated based on the above aggregation result, and the updated item embedding matrix v 314 is sent to each of the user terminal devices 302(1) and 302(2).

In the above example, it is mentioned that “the target user terminal device can perform the gradient update process of the above two-round interactions during at least one iteration of locally iteratively training an item embedding matrix and a user embedding matrix corresponding to the target scoring matrix”; it should be noted here that in this example, first, the gradient update process here is only performed for the item embedding matrix, and the user embedding matrix is always local to the user terminal device and will not be sent to the server; secondly, two-round communication interactions between the user terminal device and the server are involved in one iteration, rather than two-round interactions performed in different iterations; thirdly, in practical applications, the user terminal device can perform the process of reporting the gradient to the server in each iteration process; however, the process can also be performed once after a set number of iterations to avoid excessive interactions between the user terminal device and the server, and for example, the total number of iterations is 200, and the above two-round interaction processing is performed every 10 iterations; that is to say, only the local iteration update process is performed for the first 9 iterations in each 10 iteration processes, and the loss function gradient corresponding to the item embedding matrix and calculated in the 10^{th} iteration process is aggregated after being uploaded to the server.

The above is a solution to guarantee user privacy security through a differential privacy mechanism. In the embodiment of the present disclosure, an enhanced user privacy guarantee solution is also provided. The solution is implemented by combining a differential privacy mechanism and a secure aggregation (abbreviated as SA) mechanism. Through the SA mechanism, the communication security between the user terminal device and the server can be guaranteed. In practical applications, the SA algorithm to be specifically used may be selected according to requirements, for example, may be a single mask strategy, a double mask strategy, a secret sharing strategy, a key exchange strategy, and the like.

In summary, the core idea of secure aggregation is to use a certain mask or key to protect the gradient information sent by a user terminal device, that is, the gradient information sent by the user terminal device is kept secret before reaching the server; at the server side, the server cannot learn any content from the gradient information reported by a single user terminal device; only after the gradient information uploaded by all user terminal devices is aggregated, and the mask or the key is eliminated, can the server only see the aggregated gradient information, so that the gradient information uploaded by each of the user terminal devices cannot be distinguished.

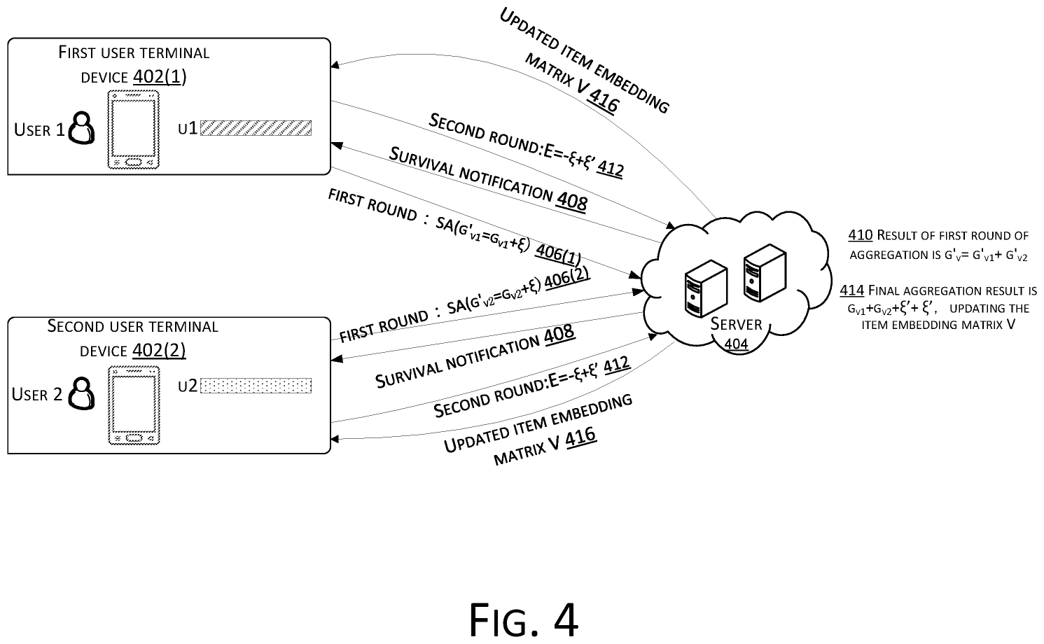

For the convenience of understanding, a situation in which the above secure aggregation is used in combination with differential privacy is exemplarily described in conjunction with FIG. 4.

The assumption in the embodiment shown in FIG. 3 is continued, the loss function gradients corresponding to the item embedding matrices calculated by the first user terminal device 402(1) and the second user terminal device 402(2) in a certain iterative process are denoted as gᵥ₁ and gᵥ₂, respectively, as shown in FIG. 4, the above first noise is denoted as and the first user terminal device 402(1) and the second user terminal device 402(2) can add the first noise to the above calculated gradients, respectively: g′ᵥ₁=gᵥ₁+ξ, g′ᵥ₂=gv₂+ξ.

As shown in FIG. 4, in a first round of interaction, the first user terminal device 402(1) and the second user terminal device 402(2) send g′ᵥ₁ and g′ᵥ₂ to the server 404, respectively at 406(1) and 406(2). However, before sending, the first user terminal device 402(1) and the second user terminal device 402(2) respectively perform security aggregation related processing on the gradient information added with the first noise, which is simply to encrypt and protect the gradient information, and the specific encryption measure is determined according to the used specific security aggregation strategy, where the respective encryption results of the first user terminal device 402(1) and the second user terminal device 402(2) are denoted as: SA(g′ᵥ₁) and SA(g′ᵥ₂). After that, the encrypted result is sent to the server 404.

If the server 404 receives the above encryption information sent by the first user terminal device 402(1), the server 404 determines that the first user terminal device 402(1) in the current iteration is surviving, and similarly, determines that the second user terminal device 402(2) in the current iteration is surviving; then, the server 404 determines that the number of the currently surviving user terminal devices is 2, and sends a survival notification 408 to the surviving first user terminal device 402(1) and second user terminal device 402(2), where the survival notification 408 may include the number of the currently surviving user terminal devices. In addition, the decoding processing can be performed on all the received encryption results by the server 404 based on a processing mode corresponding to the security aggregation strategy used by the user terminal device side, so as to realize the aggregation of the gradient information added with the first noise and uploaded by each of the user terminal devices; in FIG. 4, the aggregation result is denoted as g′ᵥ=g′ᵥ₁+g′ᵥ₂ at 410. That is to say, the server 404 obtains an addition sum result of the gradient information of the two user terminal devices 402(1) and 402(2) after the first noise is added, and does not know the specific two pieces of gradient information, because the two pieces of gradient information are protected by the corresponding keys/masks. In addition, after determining the number of the currently surviving user terminal devices, the server 404 determines whether the number of the surviving devices is less than (1-w)n; if so, the security aggregation algorithm stops processing and the next iteration process is performed, or otherwise, the server 404 sends the survival notification 408 to the above surviving first user terminal device and second user terminal device.

After receiving the above survival notification 408, the first user terminal device 402(1) and the second user terminal device 402(2) trigger a second round of interaction 412 with the server: the second noise is denoted as E, and E=−ξ+ξ′ is determined, where ξ′ is called a third noise, and the second noise is the difference between the third noise and the first noise. The third noise ξ′ may also be zero-mean Gaussian noise and denoted as (0, ξ₂σ²), ξ₂ is the variance coefficient of the third noise, the value of which is between the reciprocal of the number of the currently surviving user terminal devices and the reciprocal of the set survival number threshold. That is, if the number of the currently surviving user terminal devices is denoted as U1, then (1/U1)≤ξ₂≤1/(1-w)n. It can be seen that the third noise is smaller than the first noise. It should be noted that, since only noise information is uploaded in the second round of interaction 412 and user privacy related information is not included, the user terminal device can directly upload E to the server 404 in a plaintext manner at this time.

After that, after receiving the second noise E respectively uploaded by the first user terminal device 402(1) and the second user terminal device 402(2), the server 404 performs aggregation processing on g′ᵥ and the E uploaded by each of the user terminal devices, and the final aggregation result is gᵥ₁+gv₂+ξ′+ξ′ at 414. After that, the item embedding matrix is updated based on the above aggregation result, and, at 416, the updated item embedding matrix is sent to each of the user terminal devices 402(1) and 402(2).

In an alternative embodiment, after updating the item embedding matrix based on the aggregated gradient, the server 404 adds a differential privacy noise to the updated item embedding matrix, and send to each of the user terminal devices 402(1) and 402(2) the item embedding matrix added with the noise to protect the user privacy security. The added differential privacy noise at this time may be called a fourth noise. For example, the variance of the differential privacy noise may be determined according to the parameters defined by the differential privacy algorithm and a set number of iterations in the training process. The fourth noise can be Gaussian noise conforming to a zero-mean Gaussian distribution, and the variance z² thereof can be set as:

z²=c1η²T1n1/δ²/ε²

where c¹ is a preset constant, η is a preset sampling rate (when calculating the loss function gradient, the corresponding scoring matrix is sampled, and the gradient is calculated based on the sampling result), and T denotes the number of iterations.

In another alternative embodiment, in order to avoid the overfitting possibly occurring in the model training process, the embodiment of the present disclosure further provides an embedding clipping strategy.

In fact, the change degree of the user embedding matrix and the item embedding matrix used in each iteration process affects the change degree of the gradient, and if the change degree of the gradient is too sensitive, it easily leads to overfitting. Therefore, there is a need to limit the sensitivity of the gradient. In order to prevent the overfitting of model training, the strategy provided by a conventional solution is to clip the gradient to limit the value range of the gradient, such as limited in the value range of [−1,1]. For example, when the gradient is large, the large gradient is clipped into a smaller gradient by this gradient clipping mode, which may easily lead to the loss of effective updated information.

The embodiment of the present disclosure proposes a new solution, embedding clipping: limiting the value range of each element in the user embedding matrix and the item embedding matrix. Specifically, after updating the item embedding matrix and the user embedding matrix used in the previous iteration process based on the corresponding loss function gradient, that is, before performing the next iteration based on the update result, clipping processing is performed on the updated item embedding matrix and user embedding matrix according to an upper limit of a scoring value in the scoring matrix respectively collected by each of the plurality of user terminal devices, so as to limit a value of a vector therein.

For example, after an item embedding matrix and a user embedding matrix used in the i-1^{th} iteration process are updated according to the loss function gradient of the item embedding matrix and the loss function gradient of the user embedding matrix calculated in the i-1^{th} iteration process to obtain a user embedding matrix and an item embedding matrix to be used in the i^{th} iteration, the mapping processing can be performed on the user embedding matrix and the item embedding matrix corresponding to the i^{th} iteration according to an upper limit of a scoring value in the scoring matrix respectively collected by the plurality of user terminal devices, so as to limit the value of each vector in the user embedding matrix and the item embedding matrix corresponding to the i^{th} iteration.

It is assumed that a plurality of user terminal devices is composed of a first user terminal device and a second user terminal device, the value range of the scoring value in a first scoring matrix corresponding to the first user terminal device is [1,5], the value range of the scoring value in a second scoring matrix corresponding to the second user terminal device is [1,3], and an upper limit of the above scoring value is 5. The square value of the norm of each of the vectors in the user embedding matrix and the item embedding matrix is limited to the range of [0,5], where the 2-norm can be used. That is to say, in each iteration process, the square value of the norm of each of the vectors in the user embedding matrix and the item embedding matrix is within this range, the user embedding matrix and item embedding matrix have a limited change degree in different iterations, and the degree of the resulting change to the loss function gradient is limited.

Taking the user embedding matrix and item embedding matrix corresponding to the ith iteration as an example, the following mapping processing can be performed on the user embedding matrix and the item embedding matrix corresponding to the i^{th} iteration:

converting the values of negative elements therein into zero, that is, converting each negative element in each vector into 0; after that, for each vector in the matrix: determining a ratio of a norm of the vector to a square root of an upper limit of a scoring value; and performing normalization processing on an element in the vector according to the ratio.

For example, taking any vector Ili in the user embedding matrix as an example, it can be mapped according to the following formula:

ui/max(1,∥ui∥₂/\sqrt{R})

where R is the upper limit of a scoring value, and ∥ui₂∥ denotes the 2-norm of the vector ui.

That is to say, each element in the vector after the negative elements are converted into 0 is in the above denominator part, and the normalization processing of the vector is realized.

The differential privacy and security aggregation strategies provided in the embodiment of the present disclosure to guarantee user privacy security have been introduced above. An alternative implementation of the overall process of federated learning is generally described below:

taking any user terminal device (called a target user terminal device) among a plurality of user terminal devices participating in federated learning as an example, in the training process, it needs to perform the following steps:

locally randomly initializing a user embedding matrix, and acquiring an initialized item embedding matrix shared by the server;

Fixing the initialized item embedding matrix, and performing pre-training for a set number of iterations (such as Tp) on the user embedding matrix, wherein the clipping processing is performed on the user embedding matrix after each update based on an upper limit of a scoring value in the scoring matrix respectively collected by each of the plurality of user terminal devices, so as to limit a value of a vector therein;

after that, performing the following iterative training process until the number of iterations reaches the set value:

determining a loss function gradient corresponding to the item embedding matrix in a current iteration;

sending to the server the loss function gradient added with a first noise, so that the server determines a currently surviving user terminal device based on the received loss function gradient added with the first noise and sent by each of the user terminal devices;

in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device;

performing a next iteration according to the updated item embedding matrix and the user embedding matrix in the current iteration; and

predicting a degree of preference of the target user to the plurality of items according to the user embedding matrix and the item embedding matrix obtained at the end of training, and recommending items to the target user according to the degree of preference.

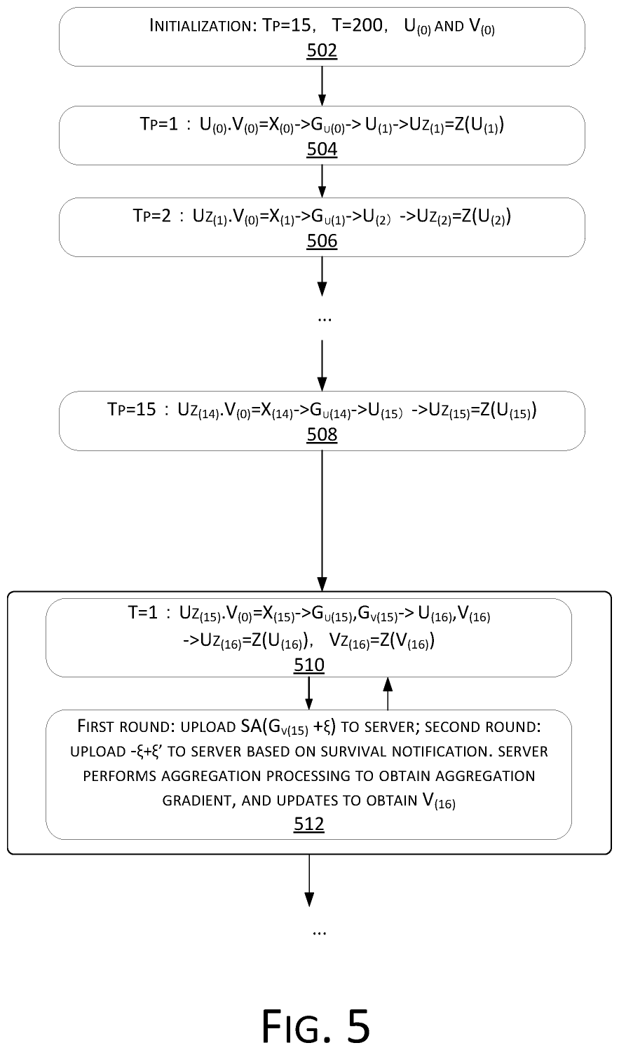

In order to intuitively understand the overall flow of the above federated learning, an exemplary description is given below in conjunction with FIG. 5.

First, the meaning of the variables shown in FIG. 5 will be explained, where U₍ᵢ₎ and V₍ᵢ₎ are used to denote the user embedding matrix and item embedding matrix used in the i^{th} iteration process, respectively, X₍ᵢ₎ is used to denote the dot product result of U₍ᵢ₎ and V₍ᵢ₎, and Gᵤ₍ᵢ₎ and Gᵥ₍ᵢ₎ are used to denote the loss function gradient corresponding to the user embedding matrix and the loss function gradient corresponding to the item embedding matrix, respectively. In addition, the first noise is denoted as ξ, and the second noise is denoted as E, where E=−ξ+ξ′, and ξ′ is the above third noise. Z( ) is used to denote the embedding clipping processing described above, and SA( ) is used to denote the security aggregation reporting processing described above. In addition, the number of iterations needs to be configured. In the embodiment of the present disclosure, for example, two variables of iteration number may be set and denoted as Tp and T, respectively, where Tp denotes the number of pre-training iterations, and T is used to denote the total number of iterations after pre-training. In the following, it is assumed that Tp=15, T=200 at initialization 502.

In an alternative embodiment, T can also be split into two variables: T1 and T2, where T1 denotes the number of groups into which T is divided, and T2 denotes the number of iterations included in each group. That is, T=T1*T2. The reason for setting T1 and T2 is to reduce the number of interactions between the user terminal device and the server, that is, the user terminal device does not need to upload the currently obtained item embedding matrix to the server for aggregation processing after each iteration, and only needs to upload the currently obtained item embedding matrix to the server for aggregation processing after T2 local iterations (small batch of iterations), thereby reducing the communication overhead between the user terminal device and the server and the calculation amount of the server. It can be understood that, when an upper limit of T2 is 1, it is the situation where the corresponding item embedding matrix is uploaded to the server for aggregation in each iteration.

In the model training process, first, for the target user terminal device, there is a need to initialize the user embedding matrix and the item embedding matrix as model parameters. Since a plurality of user terminal devices share the same item set, but the users respectively corresponding to the user terminal devices are different, random initialization processing can be performed locally on the user embedding matrix in the target user terminal device, and the initialized user embedding matrix can be denoted as U₍₀₎, while the item embedding matrix is initialized and set by the server, and the initialized user embedding matrix is distributed to each of the user terminal devices, that is, each of the user terminal devices has the same initialized item embedding matrix, while has a different initialized user embedding matrix. The initialized item embedding matrix is denoted as V₍₀₎.

After that, the target user terminal device can first perform pre-training of the user embedding matrix. At this time, the initialized item embedding matrix V₍₀₎ is fixed, and only the user embedding matrix is updated in each iteration training process; it is assumed that the user embedding matrix obtained after Tp=15 times of pre-trainings is U₍₁₅₎, and the item embedding matrix at this time is still V₍₀₎. For example, at 504, Tp=1: U(0).V(0)=X(0)->Gu(0)-> U(1)->Uz(1)=Z(U(1)). At 506, Tp=2: Uz(1).V(0)=X(1)->Gu(1)->U(2)->Uz(2)=Z(U(2)) . . . At 508, TP=15: UZ₍₁₄₎.V₍₀₎=X₍₁₄₎->Gᵤ₍₁₄₎->U₍₁₅₎->UZ₍₁₅₎=Z(U₍₁₅₎).

In the pre-training stage, only the embedding clipping processing described above may be performed without the process of adding noise. For example, as shown in FIG. 5, in a first iteration process, the target user terminal device can obtain the dot product result X₍₀₎ based on the initialized U₍₀₎ and V₍₀₎, can calculate the loss function gradient Gu₍₀₎ corresponding to the user embedding matrix based on the comparison between the dot product result and the target scoring matrix collected by the target user terminal device, and can update the initialized user embedding matrix based on the loss function gradient, with the update result being U₍₁₎. After that, the clipping processing is performed on the user embedding matrix, and the following result is obtained: U_{Z(1)}=Z(U₍₁₎). The clipping processing as described above is to clip the value of each of the vectors in the updated user embedding matrix based on an upper limit of a scoring value in the scoring matrix collected by each of the plurality of user terminal devices, so as to limit a value of a vector therein. The above operations are performed until the pre-training stage is completed, and the U_{Z(15)} shown in FIG. 5 is finally obtained.

After the above pre-training stage, a joint training stage of the user embedding matrix and the item embedding matrix can be performed.

Then, as shown in FIG. 5, at 510, when T=1, the target user terminal device can obtain the dot product result X₍₁₅₎ based on U_{Z(15)} and V₍₀₎, can calculate and obtain the loss function gradients Gᵤ₍₁₅) and Gᵥ₍₁₅₎ based on the comparison between the dot product result and the target scoring matrix collected by the target user terminal device, and can update the user embedding matrix to obtain U₍₁₆₎ based on the loss function gradient Gᵤ₍₁₅₎. However, the update processing for the item embedding matrix will perform the following operations:

The target user terminal device will perform the above “two-round interaction” process at 512: adding the first noise ξ to Gᵥ(15), reporting the gradient added with the first noise to the server by a security aggregation mode, which is denoted in FIG. 5 as: SA(Gᵥ₍₁₅₎+ξ), and sending the second noise E=−ξ+ξ′ to the server when receiving a survival notification sent by the server. The server aggregates the above two types of information received from each of the surviving user terminal devices when T=1 to obtain the aggregated gradient, updates the initial V₍₀₎ according to the aggregated gradient at this time to obtain the updated item embedding matrix V₍₁₆₎, and sends V₍₁₆₎ to the currently surviving user terminal devices. It is assumed here that the target user terminal device is surviving, therefore, after receiving V₍₁₆₎, the target user terminal device can perform embedding clipping processing on the locally updated U₍₁₆₎ and V₍₁₆₎ received from the server to obtain U_{Z(16)} and V_{Z(16)}. Then, a next iteration is proceeded, and so on, until the number of iterations reaches T=200.

In summary, aiming at a classic technical issue in a recommendation system, i.e., a matrix factorization algorithm, the solution provided by the embodiment of the present disclosure provides a federated learning framework guaranteed by data privacy theory. The above two-round interaction mechanism is provided especially for the situation where the user terminal devices of a plurality of users are combined for federated training, and differential privacy noise to be added to the gradient corresponding to each of the user terminal devices is determined based on the observed real user drop-out rate, so as to ensure that the gradient aggregation result of the server side meets the differential privacy requirement, so that the protection of user privacy information is realized.

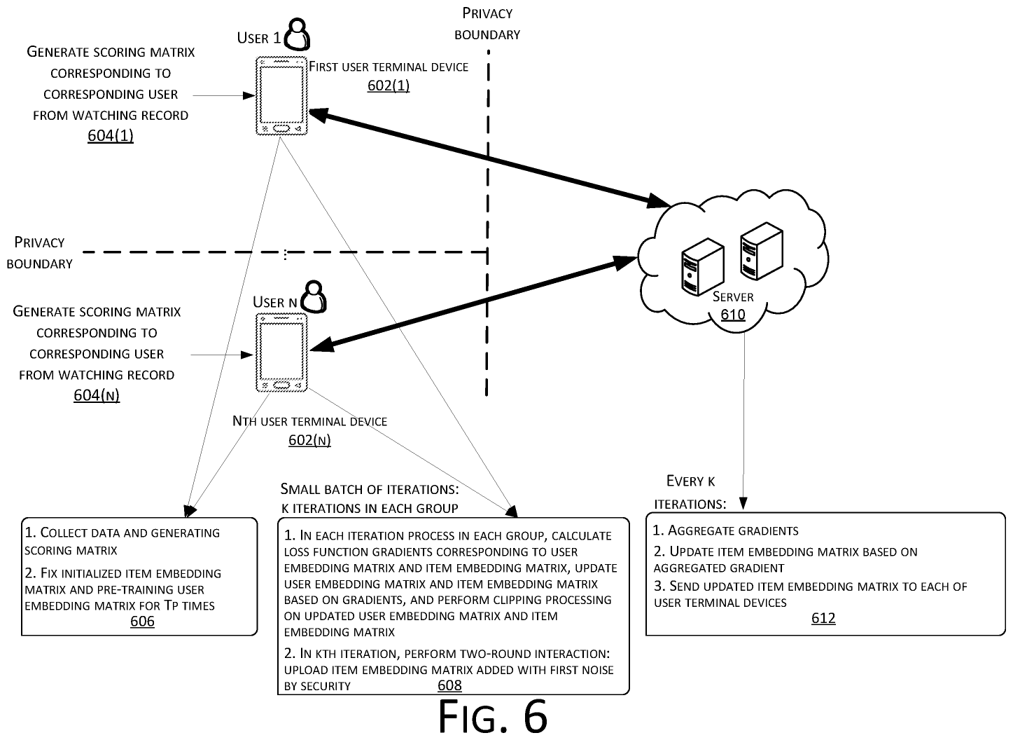

As mentioned above, the item recommendation solution provided by the embodiment of the present disclosure may be applicable to various information recommendation scenarios such as recommending commodities, film and television works, and the like. The process of performing a movie recommendation to a user is exemplarily described below in conjunction with FIG. 6.

In FIG. 6, it is assumed that each of n user terminal devices, such as first user terminal device 602(1) and nth user terminal device 602(n), where n may be any integer, has collected movie watching information of corresponding n users, and a scoring matrix can be respectively generated based on the respectively collected movie watching information at 604(1) and 604(n). For example, a scoring standard is preset (not limited to this example): if a user has watched a certain movie, the corresponding scoring value of the movie in the corresponding scoring matrix can be set as 1, and if no watching record of a movie by the user is collected, the corresponding scoring value of the movie is set as a default value. After a corresponding scoring matrix is generated in each of the n user terminal devices, as shown in FIG. 6, then user terminal devices can first keep the shared initialized item embedding matrix unchanged, and locally perform a training for multiple (Tp times) iterations of the user embedding matrix (i.e., pre-train the user embedding matrix) at 606. After that, the n user terminal devices locally perform multiple rounds of small batch of iterations, wherein the small batch of iterations is a group of multiple iteration trainings above. At 608, in each iteration process within a group, the calculation of the loss function gradients corresponding to the user embedding matrix and the item embedding matrix is performed, the user embedding matrix and the item embedding matrix are updated based on the gradients, and the clipping processing is performed on the updated user embedding matrix and item embedding matrix. In addition, in the last iteration process of each group, the “two-round interaction” processing can be performed for the currently obtained item embedding matrix: uploading the item embedding matrix added with the first noise by a security aggregation algorithm; and uploading the second noise after receiving a survival notification. In this way, the server 610 obtains the aggregated gradient based on the uploaded information of each of the user terminal devices received in the current iteration process, updates the item embedding matrix, and sends the updated item embedding matrix to each of the user terminal devices at 612. Each of the user terminal devices then performs the clipping processing on the user embedding matrix and the item embedding matrix finally obtained in this iteration for the next iteration.

After all iterations are completed, each user terminal device can obtain its private user embedding matrix and a shared item embedding matrix. Based on this, for example, for a certain user i, the predicted scoring value of each movie corresponding to the item embedding matrix by user i can be obtained by performing dot product using the user embedding matrix and item embedding matrix corresponding to the user i, the predicted scoring value reflects the degree of preference of the user, and the higher the scoring value is, the more preferred the movie is, so that the more preferred movie can be recommended to the user.

Item recommendation apparatuses of one or more embodiments of the present disclosure will be described in detail below. Those skilled in the art may appreciate that all of these apparatuses may be formed by configuring and using commercially available hardware components through the steps taught in this solution.

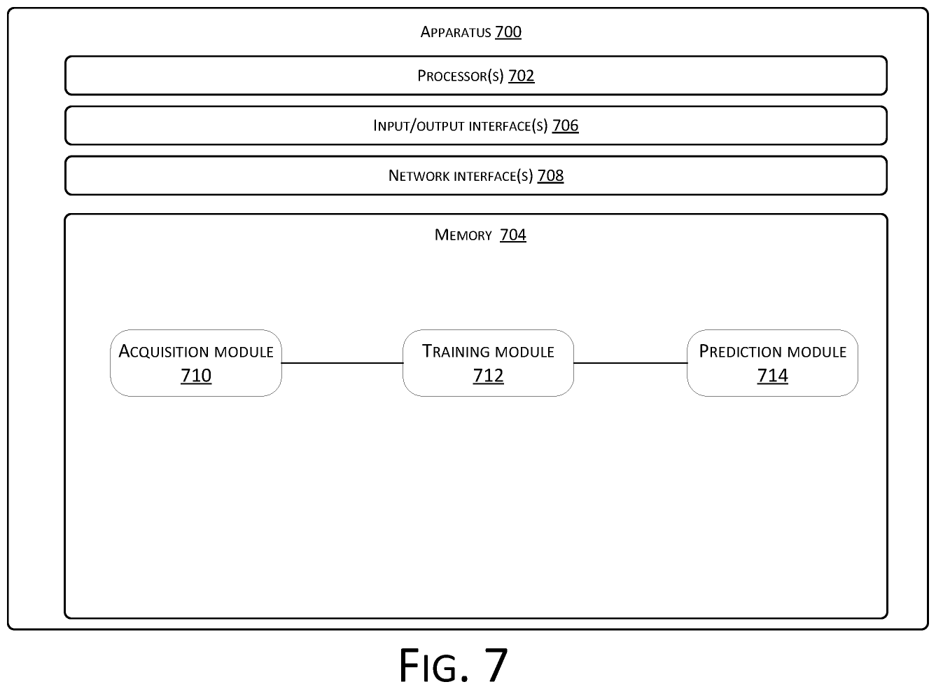

FIG. 7 is a schematic structural diagram of an item recommendation apparatus according to an embodiment of the present disclosure, and the item recommendation apparatus is located in any user terminal device among a plurality of user terminal devices configured to perform federated learning. As shown in FIG. 7, the apparatus 700 includes one or more processor(s) 702 or data processing unit(s) and memory 704. The apparatus 700 may further include one or more input/output interface(s) 706 and one or more network interface(s) 708. The memory 704 is an example of computer-readable media.

Computer-readable media further include non-volatile and volatile, removable and non-removable media employing any method or technique to achieve information storage. The information may be computer-readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic tape, a magnetic disk storage or other magnetic storage devices, or any other non-transmission medium, which may be used to store information that can be accessed by a computing device. As defined herein, the computer-readable media do not include transitory media, such as modulated data signals and carriers.

The memory 704 may store therein a plurality of modules or units including: an acquisition module 710, a training module 712, and a prediction module 714.

The acquisition module 710 is configured to locally acquire a target scoring matrix corresponding to the target user, wherein the target scoring matrix is configured to describe a scoring situation of the target user on a plurality of items, and a scoring matrix collected by each of the plurality of user terminal devices has the same item set.

The training module 712 is configured to perform the following operations during at least one iteration of locally iteratively training an item embedding matrix and a user embedding matrix corresponding to the target scoring matrix: determining a loss function gradient corresponding to the item embedding matrix in a current iteration; sending to a server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; and performing a next iteration according to the updated item embedding matrix and the user embedding matrix in the current iteration.

The prediction module 714 is configured to predict a degree of preference of the target user to the plurality of items according to the user embedding matrix and the item embedding matrix obtained at the end of training, and recommend items to the target user according to the degree of preference.

For example, the first noise is zero-mean Gaussian noise, the first noise has a first variance coefficient, the first variance coefficient is greater than or equal to the reciprocal of a set survival number threshold, and the set survival number threshold is determined according to a set drop-out rate and the total number of the plurality of user terminal devices.

For example, the survival notification comprises the number of the currently surviving user terminal devices; and the second noise is the difference between a third noise and the first noise, the third noise is zero-mean Gaussian noise, the third noise has a second variance coefficient, and a value of the second variance coefficient is between the reciprocal of the number of the currently surviving user terminal devices and the reciprocal of the set survival number threshold.

For example, the training module 712, in the process of sending to the server the loss function gradient added with the first noise, is specifically configured to: perform encryption processing on the loss function gradient added with the first noise by using a set security aggregation algorithm, and send an encryption result to the server.

For example, before performing a next iteration according to the updated item embedding matrix and the user embedding matrix in the current iteration, the training module 712 is further configured to: perform clipping processing on the updated item embedding matrix and the user embedding matrix in the current iteration according to an upper limit of a scoring value in the scoring matrix collected by each of the plurality of user terminal devices, so as to limit a value of a vector therein.

For example, the clipping processing comprises converting the negative values therein into zero; for each vector therein: determining a ratio of a norm of the vector to a square root of an upper limit of a scoring value; and performing normalization processing on an element in the vector according to the ratio.

For example, the training module 712, in the process of locally iteratively training an item embedding matrix and a user embedding matrix corresponding to the target scoring matrix, is further configured to:

locally randomly initialize the user embedding matrix, and acquire an initialized item embedding matrix shared by the server; and

fix the initialized item embedding matrix, and perform pre-training for a set number of iterations on the user embedding matrix, wherein clipping processing is performed on the user embedding matrix after each update based on an upper limit of a scoring value in the scoring matrix collected by each of the plurality of user terminal devices, so as to limit a value of a vector therein.

The apparatus shown in FIG. 7 may perform the steps performed by the user terminal device in the foregoing embodiment, and for details of the performing process and the technical effect, reference is made to the description in the foregoing embodiment, which will not be repeated in detail here.

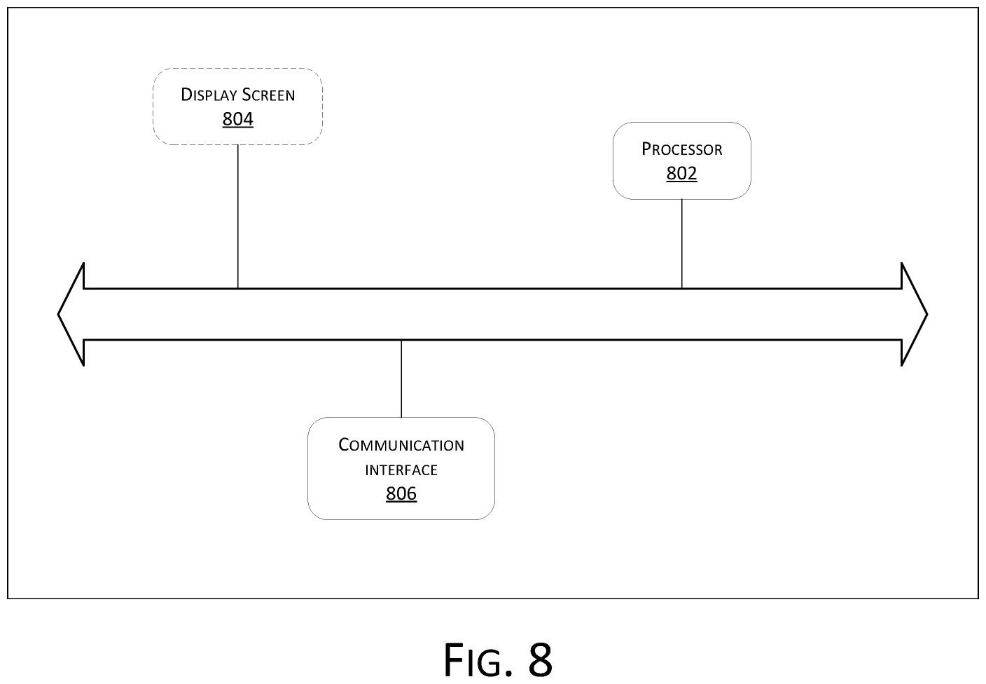

In a possible design, the structure of the item recommendation apparatus shown in FIG. 7 can be implemented as a user terminal device, such as a smartphone, a PC, a tablet computer, and the like, and the user terminal device is any user terminal device among a plurality of user terminal devices configured to perform federated learning. As shown in FIG. 8, the user terminal device may include a processor 802 and a display screen 804.

The processor 802 is configured to locally acquire a target scoring matrix corresponding to the target user, wherein the target scoring matrix is configured to describe a scoring situation of the target user on a plurality of items, and a scoring matrix collected by each of the plurality of user terminal devices has the same item set; and perform the following operations during at least one iteration of locally iteratively training an item embedding matrix and a user embedding matrix corresponding to the target scoring matrix: determining a loss function gradient corresponding to the item embedding matrix in a current iteration; sending to a server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; performing a next iteration according to the updated item embedding matrix and the user embedding matrix in the current iteration; and predicting a degree of preference of the target user to the plurality of items according to the user embedding matrix and the item embedding matrix obtained at the end of training, and recommending items to the target user according to the degree of preference.

The display screen 804 is coupled to the processor 802 and configured to display the items recommended to the target user.

As shown in FIG. 8, the user terminal device further includes a communication interface 806 for communicating with the server.

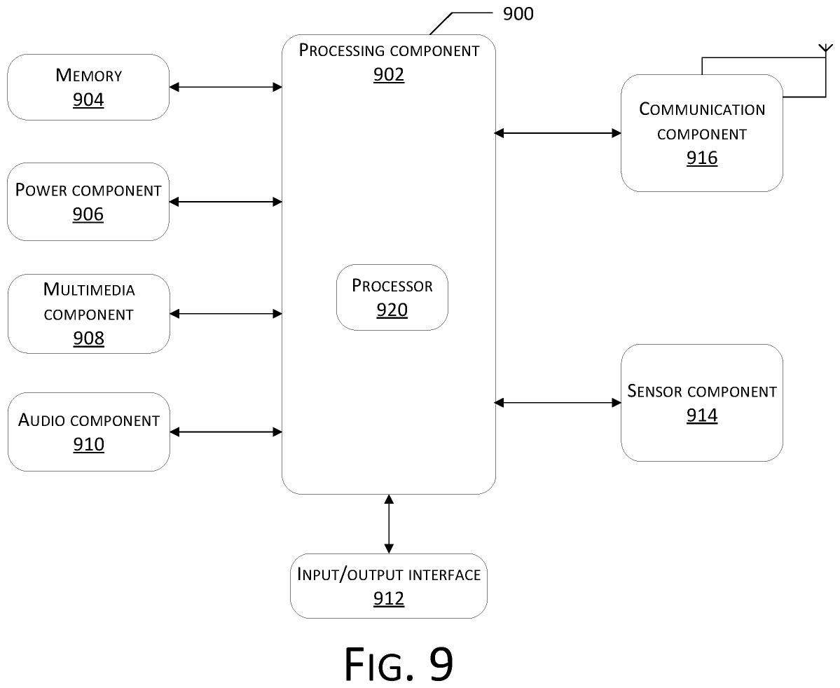

FIG. 9 is a schematic structural diagram of another user terminal device according to the present embodiment. As shown in FIG. 9, the user terminal device 900 may include one or more of the following components: a processing component 902, a memory 904, a power component 906, a multimedia component 908, an audio component 910, an input/output (I/O) interface 912, a sensor component 914, and a communication component 916.

The processing component 902 generally controls the overall operation of the user terminal device 900, such as operations associated with display, phone calls, data communications, camera operations, and recording operations. The processing component 902 may include one or more processors 920 to execute instructions to complete all or part of the above method steps performed by the target terminal device. Additionally, the processing component 902 may include one or more modules to facilitate interaction between the processing component 902 and other components. For example, the processing component 902 may include a multimedia module to facilitate interaction between the multimedia component 808 and the processing component 902.

The memory 904 is configured to store various types of data to support operations on the user terminal device 900. Examples of such data include instructions, contact data, phonebook data, messages, pictures, videos, and the like used for any application program or method operating on the user terminal device 900. The memory 904 may be implemented by any type of volatile or non-volatile memory device or a combination thereof, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 906 provides power to various components of the user terminal device 900. The power components 906 may include a power management system, one or more power supplies, and other components associated with generating, managing, and distributing power for the user terminal device 900.

The multimedia component 908 includes a screen that provides an output interface between the user terminal device 900 and a user. In some embodiments, the screen may include a liquid crystal display (LCD) and a touch panel (TP). If the screen includes the touch panel, the screen may be implemented as a touch screen to receive input signals from a user. The touch panel includes one or more touch sensors to sense touch, swiping, and gestures on the touch panel. The touch sensor may not only sense the boundary of a touch or swipe action, but also detect the duration and pressure related to the touch or swipe operation. In some embodiments, the multimedia component 908 includes a front-facing camera and/or a rear-facing camera. When the user terminal device 900 is in an operation mode, such as a shooting mode or a video mode, the front-facing camera and/or the rear-facing camera may receive external multimedia data. Each of the front-facing camera and/or the rear-facing camera can be a fixed optical lens system or have focal length and optical zoom capability.

The audio component 910 is configured to output and/or input audio signals. For example, the audio component 910 includes a microphone (MIC) configured to receive an external audio signal when the user terminal device 900 is in an operating mode, for example, in a call mode, a recording mode, and a voice recognition mode. The received audio signal may be further stored in a memory 904 or sent through a communication component 916. In some embodiments, the audio component 910 further includes a speaker for outputting an audio signal.

The input/output interface 912 provides an interface between the processing component 902 and a peripheral interface module that may be a keyboard, a click wheel, buttons, or the like. These buttons may include, but are not limited to, home button, volume buttons, start button, and lock button.

The sensor component 914 includes one or more sensors for providing status assessment of various aspects of the user terminal device 900. For example, the sensor component 914 can detect the open/closed state of the user terminal device 900, and the relative positioning of components such as the display and keypad of the electronic device 900. The sensor component 914 can also detect a change in the position of the user terminal device 800 or a component of the user terminal device 900, the presence or absence of the user contact with the user terminal device 900, orientation or acceleration/deceleration of the user terminal device 900, and temperature changes of the user terminal device 900. The sensor component 914 may include a proximity sensor configured to detect the presence of nearby objects in the absence of any physical contact. The sensor component 914 may also include a light sensor such as a CMOS or CCD image sensor for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communications between the user terminal device 900 and other devices. The user terminal device 900 can access radio networks based on communication standards, such as WiFi, 2G, 3G, 4G, or a combination thereof. In an exemplary embodiment, the communication component 916 receives, through a broadcast channel, broadcast signals or broadcast-related information from an external broadcast management system. In an exemplary embodiment, the communication component 916 further comprises a near field communication (NFC) module to facilitate short range communications. For example, the NFC module can be implemented based on the radio frequency identifier (RFID) technology, the infrared data association (IrDA) technology, the ultra-wideband (UWB) technology, the Bluetooth (BT) technology, and other technologies.

In an exemplary embodiment, the user terminal device 900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the above methods.

In an exemplary embodiment, a non-transitory computer-readable storage medium including instructions is further provided, such as a memory 904 including instructions, and the above instructions can be executed by the processor 920 of the user terminal device 900 to complete the above method. For example, the non-transitory computer-readable storage medium may be implemented by any type of volatile or non-volatile memory device or a combination thereof, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

In addition, an embodiment of the present disclosure provides a non-transitory machine-readable storage medium, wherein the non-transitory machine-readable storage medium has executable codes stored thereon, which when executed by a processor of a user terminal device, cause the processor at least can implement the item recommendation method as provided in the foregoing embodiments.

The apparatus embodiments described above are only examples, wherein the units described as separate components may or may not be physically separated. Some or all of the modules may be selected according to actual needs to achieve the objectives of the solutions of the embodiments. Those of ordinary skill in the art may understand and implement the embodiments without creative efforts.

Through the description of the above implementations, a person skilled in the art may clearly understand that each implementation may be realized by means of a necessary general hardware platform, and may certainly be implemented by a combination of hardware and software. Based on such an understanding, the part of the above technical solutions, which is essential or contributes to the conventional techniques, may be embodied in the form of a computer product. The present disclosure may take the form of a computer program product which is embodied on one or more computer-usable storage media (including, but not limited to, disk storage, CD-ROM, optical storage, and so forth) having computer-usable program code contained therein.

Finally, it should be noted that the above embodiments are merely used for illustrating, rather than limiting, the technical solutions of the present disclosure. Although the present disclosure is described in detail with reference to the afore-mentioned embodiments, it should be understood by those of ordinary skill in the art that modifications may still be made to the technical solutions described in the afore-mentioned embodiments, or equivalent substitutions may be applied to part of the technical features therein; and these modifications or substitutions do not cause the essence of corresponding technical solutions to depart from the spirit and scope of the technical solutions in the embodiments of the present disclosure.

The present disclosure may further be understood with clauses as follows.

Clause 1. A distributed privacy-preserving learning system, the system comprising:

a plurality of user terminal devices configured to perform federated learning, and a server; wherein the plurality of user terminal devices corresponds to a plurality of users one by one; a scoring matrix collected by each of the plurality of user terminal devices has the same item set;

a target user terminal device among the plurality of user terminal devices is configured to locally acquire a target scoring matrix corresponding to a target user, and perform the following operations during at least one iteration of locally iteratively training an item embedding matrix and a user embedding matrix corresponding to the target scoring matrix: determining a loss function gradient corresponding to the item embedding matrix in a current iteration; sending to the server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; performing a next iteration according to the updated item embedding matrix and the user embedding matrix in the current iteration; and predicting a degree of preference of the target user to the plurality of items according to the user embedding matrix and the item embedding matrix obtained at the end of training, and recommending items to the target user according to the degree of preference; and

the server is configured to receive the loss function gradient added with the first noise and uploaded by each of the user terminal devices in the current iteration, determine the currently surviving user terminal device, and send the survival notification to the currently surviving user terminal device; and receive the second noise sent by the currently surviving user terminal device, update the item embedding matrix based on the aggregation result of the loss function gradient added with the first noise and the second noise, and send the updated item embedding matrix to the surviving user terminal device.

Clause 2. The system according to clause 1, wherein the first noise is zero-mean Gaussian noise and has a first variance coefficient, the first variance coefficient is greater than or equal to the reciprocal of a set survival number threshold, and the set survival number threshold is determined according to a set drop-out rate and the total number of the plurality of user terminal devices;

the survival notification comprises the number of the currently surviving user terminal devices; and the second noise is the difference between a third noise and the first noise, the third noise is zero-mean Gaussian noise and has a second variance coefficient, and a value of the second variance coefficient is between the reciprocal of the number of the currently surviving user terminal devices and the reciprocal of the set survival number threshold.

Clause 3. The system according to clause 1, wherein the target user terminal device, in the process of sending to the server the loss function gradient added with the first noise, is configured to: perform encryption processing on the loss function gradient added with the first noise by using a set security aggregation algorithm, and send an encryption result to the server.

Clause 4. A recommendation method for distributed privacy-preserving learning, wherein the method is applied to a target user terminal device among a plurality of user terminal devices configured to perform federated learning, the target user terminal device corresponds to a target user, and the method comprises:

locally acquiring a target scoring matrix corresponding to the target user, wherein the target scoring matrix is configured to describe a scoring situation of the target user on a plurality of items, and a scoring matrix collected by each of the plurality of user terminal devices has the same item set; and

performing the following operations during at least one iteration of locally iteratively training an item embedding matrix and a user embedding matrix corresponding to the target scoring matrix:

determining a loss function gradient corresponding to the item embedding matrix in a current iteration;

sending to the server the loss function gradient added with a first noise, so that the server determines a currently surviving user terminal device based on the received loss function gradient added with the first noise and sent by each of the user terminal devices;

in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device;

performing a next iteration according to the updated item embedding matrix and the user embedding matrix in the current iteration; and

predicting a degree of preference of the target user to the plurality of items according to the user embedding matrix and the item embedding matrix obtained at the end of training, and recommending items to the target user according to the degree of preference.

Clause 5. The method according to clause 4, wherein the first noise is zero-mean Gaussian noise and has a first variance coefficient, the first variance coefficient is greater than or equal to the reciprocal of a set survival number threshold, and the set survival number threshold is determined according to a set drop-out rate and the total number of the plurality of user terminal devices.

Clause 6. The method according to clause 5, wherein the survival notification comprises the number of the currently surviving user terminal devices; and the second noise is the difference between a third noise and the first noise, the third noise is zero-mean Gaussian noise and has a second variance coefficient, and a value of the second variance coefficient is between the reciprocal of the number of the currently surviving user terminal devices and the reciprocal of the set survival number threshold.

Clause 7. The method according to clause 4, wherein the step of sending to the server the loss function gradient added with a first noise comprises:

performing encryption processing on the loss function gradient added with the first noise by using a set security aggregation algorithm, and sending an encryption result to the server.

Clause 8. The method according to clause 4, wherein prior to the step of performing a next iteration according to the updated item embedding matrix and the user embedding matrix in the current iteration, the operations comprise:

performing clipping processing on the updated item embedding matrix and the updated user embedding matrix according to an upper limit of a scoring value in the scoring matrix collected by each of the plurality of user terminal devices, so as to limit a value of a vector therein.

Clause 9. The method according to clause 8, wherein the clipping processing comprises:

converting a negative value therein into zero; and

for each vector therein: determining a ratio of a norm of the vector to a square root of the upper limit of the scoring value; and performing normalization processing on an element in the vector according to the ratio.

Clause 10. The method according to clause 4, wherein the process of locally iteratively training an item embedding matrix and a user embedding matrix corresponding to the target scoring matrix further comprises:

locally randomly initializing the user embedding matrix, and acquiring an initialized item embedding matrix shared by the server; and

fixing the initialized item embedding matrix, and performing pre-training for a set number of iterations on the user embedding matrix, wherein clipping processing is performed on the user embedding matrix after each update based on an upper limit of a scoring value in the scoring matrix collected by each of the plurality of user terminal devices, so as to limit a value of a vector therein.

Clause 11. A user terminal device, wherein the user terminal device is a target user terminal device among a plurality of user terminal devices configured to perform federated learning, and the target user terminal device corresponds to a target user and comprises a processor and a display screen; wherein the processor is configured to locally acquire a target scoring matrix corresponding to the target user, wherein the target scoring matrix is configured to describe a scoring situation of the target user on a plurality of items, and a scoring matrix collected by each of the plurality of user terminal devices has the same item set; and perform the following operations during at least one iteration of locally iteratively training an item embedding matrix and a user embedding matrix corresponding to the target scoring matrix: determining a loss function gradient corresponding to the item embedding matrix in a current iteration; sending to a server the loss function gradient added with a first noise, so that the server determines a currently surviving user terminal device based on the received loss function gradient added with the first noise and sent by each of the user terminal devices; in response to receiving a survival notification sent by the server, sending to the server a second noise for reducing the noise added to the loss function gradient, so that the server updates the item embedding matrix based on an aggregation result of the loss function gradient added with the first noise and the second noise, and sends the updated item embedding matrix to the surviving user terminal device; performing a next iteration according to the updated item embedding matrix and the user embedding matrix in the current iteration; and predicting a degree of preference of the target user to the plurality of items according to the user embedding matrix and the item embedding matrix obtained at the end of training, and recommending items to the target user according to the degree of preference; and

the display screen is coupled to the processor and configured to display the items recommended to the target user.

Clause 12. A non-transitory machine-readable storage medium, wherein the non-transitory machine-readable storage medium has executable codes stored thereon, which when executed by a processor of a user terminal device, cause the processor to perform the recommendation method for distributed privacy-preserving learning according to any one of clauses 4 to 10.

What is claimed is:

1. A method performed by a target terminal device corresponding to a target user, the method comprising:
acquiring a target scoring matrix corresponding to the target user, the target scoring matrix describing a scoring situation of the target user on a plurality of items; and
performing, during at least one iteration of locally iteratively training an item embedding matrix and a user embedding matrix corresponding to the target scoring matrix, operations including:
determining a loss function gradient corresponding to the item embedding matrix in a current iteration;
sending to a server the loss function gradient added with a first noise;
in response to receiving a survival notification sent by the server, sending to the server a second noise for reducing the first noise added to the loss function gradient;
performing a next iteration according to the item embedding matrix that is updated by the server and the user embedding matrix in the current iteration;
predicting a degree of preference of the target user to the plurality of items according to the user embedding matrix and the item embedding matrix obtained at an end of training; and
recommending one or more items to the target user according to the degree of preference.

2. The method according to claim 1, wherein:
the target terminal device is among a plurality of user terminal devices configured to perform federated learning; and
a scoring matrix collected by each of the plurality of user terminal devices has a same item set.

3. The method according to claim 2, further comprising:
determining, by the server, a surviving user terminal device based on the loss function gradient added with the first noise and sent by each of the plurality of user terminal devices.

4. The method according to claim 3, further comprising:
updating, by the server, the item embedding matrix based on an aggregation result of the loss function gradient added with the first noise and the second noise; and
sending, by the server, the item embedding matrix that is updated to the surviving user terminal device.

5. The method according to claim 2, wherein:
the first noise is zero-mean Gaussian noise and has a first variance coefficient;
the first variance coefficient is greater than or equal to a reciprocal of a set survival number threshold; and
the set survival number threshold is determined according to a set drop-out rate and a total number of the plurality of user terminal devices.

6. The method according to claim 1, wherein the survival notification comprises a number of currently surviving user terminal devices.

7. The method according to claim 6, wherein:
the second noise is a difference between a third noise and the first noise;
the third noise is zero-mean Gaussian noise and has a second variance coefficient; and
a value of the second variance coefficient is between a reciprocal of the number of the currently surviving user terminal devices and a reciprocal of set survival number threshold.

8. The method according to claim 1, wherein the sending to the server the loss function gradient added with the first noise comprises:
performing encryption processing on the loss function gradient added with the first noise by using a security aggregation algorithm; and
sending an encryption result to the server.

9. The method according to claim 1, wherein prior to the performing the next iteration according to the item embedding matrix that is updated by the server and the user embedding matrix in the current iteration, the operations further include:
performing clipping processing on the item embedding matrix that is updated and the user embedding matrix that is updated according to an upper limit of a scoring value in the target scoring matrix collected by each of a plurality of user terminal devices, so as to limit a value of a vector therein.

10. The method according to claim 9, wherein the clipping processing comprises:
converting a negative value therein into zero; and
for each vector therein: determining a ratio of a norm of the vector to a square root of the upper limit of the scoring value; and
performing normalization processing on an element in the vector according to the ratio.

11. The method according to claim 1, wherein the operations further comprise:
locally randomly initializing the user embedding matrix, and acquiring an initialized item embedding matrix shared by the server; and
fixing the initialized item embedding matrix, and performing pre-training for a set number of iterations on the user embedding matrix, wherein clipping processing is performed on the user embedding matrix after each update based on an upper limit of a scoring value in the target scoring matrix collected by each of the plurality of user terminal devices, so as to limit a value of a vector therein.

12. A server comprising:
one or more processors; and
one or more memories storing thereon computer-readable instructions that, when executed by the one or more processors, cause the one or more processors to perform acts comprising:
receive a loss function gradient added with a first noise and uploaded by each of a plurality of user terminal devices in a current iteration;
determining a currently surviving user terminal device;
sending a survival notification to the currently surviving user terminal device;
receiving a second noise sent by the currently surviving user terminal device,
updating an item embedding matrix based on ab aggregation result of the loss function gradient added with the first noise and the second noise; and
sending the updated item embedding matrix to the currently surviving user terminal device.

13. The server according to claim 12, wherein:
the first noise is zero-mean Gaussian noise and has a first variance coefficient;
the first variance coefficient is greater than or equal to a reciprocal of a set survival number threshold; and
the set survival number threshold is determined according to a set drop-out rate and a total number of the plurality of user terminal devices.

14. The server according to claim 12, wherein the survival notification comprises a number of currently surviving user terminal devices.

15. The server according to claim 14, wherein:
the second noise is a difference between a third noise and the first noise;
the third noise is zero-mean Gaussian noise and has a second variance coefficient; and
a value of the second variance coefficient is between a reciprocal of the number of the currently surviving user terminal devices and a reciprocal of set survival number threshold.

16. A system comprising:
a target terminal device corresponding to a target user, the target terminal device including:
one or more processors; and
one or more memories storing thereon computer-readable instructions that, when executed by the one or more processors, cause the one or more processors to perform acts including:
acquiring a target scoring matrix corresponding to the target user, the target scoring matrix describing a scoring situation of the target user on a plurality of items; and
performing, during at least one iteration of locally iteratively training an item embedding matrix and a user embedding matrix corresponding to the target scoring matrix, operations including:
determining a loss function gradient corresponding to the item embedding matrix in a current iteration;
sending to a server the loss function gradient added with a first noise so that the server determines a currently surviving user terminal device based on the loss function gradient added with the first noise and sent by a plurality of user terminal devices;
in response to receiving a survival notification sent by the server, sending to the server a second noise for reducing the first noise added to the loss function gradient so that the server updates the item embedding matrix based on an aggregation result of the loss function gradient added with the first noise and the second noise;
performing a next iteration according to the item embedding matrix that is updated by the server and the user embedding matrix in the current iteration;
predicting a degree of preference of the target user to the plurality of items according to the user embedding matrix and the item embedding matrix obtained at an end of training; and
recommending one or more items to the target user according to the degree of preference.

17. The system according to claim 16, comprising:
the plurality of user terminal devices that perform federated learning, wherein the plurality of user terminal devices corresponds to a plurality of users respectively.

18. The system according to claim 16, wherein a scoring matrix collected by each of the plurality of user terminal devices has a same item set;

19. The system according to claim 18, further comprising the server, the server comprising:
another one or more processors; and
another one or more memories storing thereon computer-readable instructions that, when executed by the another one or more processors, cause the another one or more processors to perform operations comprising:
receive the loss function gradient added with a first noise and uploaded by each of the plurality of user terminal devices in the current iteration;
determining the currently surviving user terminal device;
sending the survival notification to the currently surviving user terminal device;
receiving the second noise sent by the currently surviving user terminal device,
updating the item embedding matrix based on an aggregation result of the loss function gradient added with the first noise and the second noise; and
sending the updated item embedding matrix to a surviving user terminal device.

20. The system according to claim 16, wherein the survival notification comprises a number of currently surviving user terminal devices.
